(19) United States
(12) Patent Application Publication
(10) Pub. No.: US 2025/0245789 A1
(43) Pub. Date: Jul. 31, 2025

(54) Error-Aware Adaptive Video Interpolation

(71) Applicant: Meta Platforms Technologies, LLC, Menlo Park, CA (US)

(72) Inventors: Xiaoyu Xiang, Sunnyvale, CA (US); Rakesh Ranjan, Mountain View, CA (US); Bo Zhu, Palo Alto, CA (US)

(21) Appl. No.: 18/426,015

(22) Filed: Jan. 29, 2024

(51) Int. Cl. G06T 5/60; G06T 5/50; G06T 7/00; G06T 7/246

(52) U.S. Cl. CPC G06T 5/60; G06T 5/50; G06T 7/0002; G06T 7/248; G06T 2207/10016; G06T 2207/20081; G06T 2207/20212; G06T 2207/30168

(57) ABSTRACT

A device may generate, based on a first input frame and a second input frame of an input video, a first feature map and a second feature map. The device may generate a forward optical flow map and a backward optical flow map based on the first feature map and the second feature map. The device may generate an error estimate for the interpolated frame using the forward optical flow map and backward optical flow map. The device may select, based on a comparison of the error estimate and one or more criteria, an interpolation module from a plurality of interpolation modules. The device may generate the interpolated frame using the selected interpolation module. The device may combine the interpolated frame with the two input frames to generate at least a part of an output video.

### TECHNICAL FIELD

This disclosure generally relates video processing, and more particularly to video frame interpolation.

### BACKGROUND

Video frame interpolation is the technique for synthesizing intermediate video frames between adjacent video frames. A video contains a sequence of image frames that, when displayed in quick succession, produces the visual effect of motion. A given video could have an intended playback speed, measured in frames per second (fps). For example, the intended playback speed could be 30 fps.

In certain applications, it may be desirable to increase the number of frames in a given video so that it can achieve a higher playback speed, such as 60 fps or 120 fps. For example, a display may be configured to output content at 60 fps, but generating a video at that same rate may be impractical or impossible due to system limitations (e.g., the computation resources may be limited, such as on a mobile device or virtual reality or augmented reality headset). Rendering a video at a high frame rate may also be challenging if the scene is complex and/or the desired resolution is high. In such cases, video interpolation may be used to convert a video with a relatively low frame rate (e.g., 30 fps) into a video with a higher frame rate (e.g., 60, 90, or 120 fps). As another example, some applications may wish to generate a slow-motion effect for a given video. If the video originally had 30 fps, doubling the number of frames by generating a synthesized frame between each pair of the original frames would result in 60 frames for each second. If the playback speed remains to be 30 fps, the end effect is a two-times slowdown of the motion in the video since the same motion captured in the 60 frames is being displayed across two seconds.

Video frame interpolation solves the difficult problem of synthesizing missing content (i.e., interpolated frames) from known content (i.e., the adjacent frames). It is difficult for a given video frame interpolation module to be able to robustly handle all videos, the variety of which could be limitless. Even if the module is able to correctly generate intermediate frames for certain video clips, it might not be able to do so for others. Certain scenes could be particularly challenging for video frame interpolation, such as those with significant motion and/or indistinguishable repeating patterns. In those cases, the synthesized intermediate frames may have artifacts, distortions, and hallucinations that are incorrect. When that occurs, the resulting output video would include incorrectly generated frames interlaced with the original frames, resulting in a jittery or unpleasant viewing experience.

### SUMMARY OF PARTICULAR EMBODIMENTS

Particular embodiments described in this disclosure are directed to a robust video frame interpolation technique that adaptively selects the manner in which interpolated frames are synthesized based on their anticipated error level. According to the embodiments described herein, a video interpolation pipeline may be configured to process a sequence of frames in an input video to generate an output video with more frames than the input video (e.g., the number of frames may double or triple). When generating each interpolated frame, the video interpolation pipeline would first estimate an error before the desired interpolated frame is actually generated. The estimated error represents a difficulty level of the current interpolation operation based on the input frames from which the interpolated frame is to be generated. Thus, the estimated error could also be interpreted as a likelihood that the interpolated frame, once generated, would be error-prone. Based on the estimated error, the pipeline could select, in real-time, different techniques to generate the interpolated frame. For example, if the estimated error is low, the pipeline may continue to synthesize the interpolated frame using a machine-learning model. On the other hand, a high estimated error would indicate that the interpolated frame, if generated using machine learning, would likely be error-prone. As such, when the estimated error is high, the pipeline may alternatively select another algorithmic module to generate the interpolated frame. For example, it may even be preferable to duplicate the first input frame and use it as the interpolated frame instead of using an interpolated frame with significant visual artifacts or inaccuracies. Thus, embodiments described herein provide a robust and practical frame interpolation technique capable of making real-time interpolation decisions on the fly.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

Summary of particular embodiments described herein are provided below. The methods described below may be implemented via a computing system or one or more computer-readable non-transitory storage media embodying software.

Clause 1. A method for generating an interpolated frame, comprising generating, based on a first input frame and a second input frame of an input video, a first feature map and a second feature map; generating a forward optical flow map and a backward optical flow map based on the first feature map and the second feature map; generating an error estimate using the forward optical flow map and backward optical flow map; selecting, based on a comparison of the error estimate and one or more criteria, an interpolation module from a plurality of interpolation modules; generating the interpolated frame using the selected interpolation module; and combining the interpolated frame with the two input frames to generate at least a part of an output video.

Clause 2. The method of Clause 1, further comprising: generating a first warped feature map using the forward optical flow map and the first feature map associated with the first input frame, the first warped feature map being associated with a desired time for which the interpolated frame is to be generated; and generating a second warped feature map using the backward optical flow map and the second feature map associated with the second input frame, the second warped feature map being associated with the desired time; wherein the first warped feature map and the second warped feature map are processed by the selected interpolation module to generate the interpolated frame.

Clause 3. The method of any combination of the preceding Clauses, further comprising: generating a first warped input frame using the forward optical flow map and the first input frame, the first warped input frame being associated with the desired time for which the interpolated frame is to be generated; and generating a second warped input frame using the backward optical flow map and the second input frame, the second warped input frame being associated with the desired time; wherein the first warped input frame and the second warped input frame are additionally processed by the selected interpolation module to generate the interpolated frame.

Clause 4. The method of any combination of the preceding Clauses, wherein the comparison indicates that the error estimate is higher than a predetermined criterion, wherein the selected interpolation module generates the interpolated frame by duplicating either the first input frame or the second input frame.

Clause 5. The method of any combination of the preceding Clauses, wherein the comparison indicates that the error estimate is lower than a predetermined criterion, wherein the selected interpolation module is a machine-learning model.

Clause 6. The method of any combination of the preceding Clauses, wherein the machine-learning model is trained to process at least the first warped feature map and the second warped feature map to generate the interpolated frame.

Clause 7. The method of any combination of the preceding Clauses, wherein the machine-learning model is jointly trained in an end-to-end manner with one or more additional machine-learning models used to generate (1) the first feature map and the second feature map and (2) the forward optical flow map and the backward optical flow map.

### BRIEF DESCRIPTION OF THE DRAWINGS

FIG. 1 provides a visualization of the video interpolation problem.

FIG. 2A and FIG. 2B illustrate examples of interpolated frames with noticeable errors.

FIG. 3 illustrates a block diagram of a frame interpolation pipeline 300, according to particular embodiments.

FIG. 4 illustrates a flow diagram representing a technique for predicting the quality of interpolated frames before they are generated and using the predictions to make interpolation decisions in real-time.

FIG. 5 illustrates an example method 500 for video interpolation.

FIG. 6 illustrates an example computer system 600 that may be used to perform video interpolation.

### DESCRIPTION OF EXAMPLE EMBODIMENTS

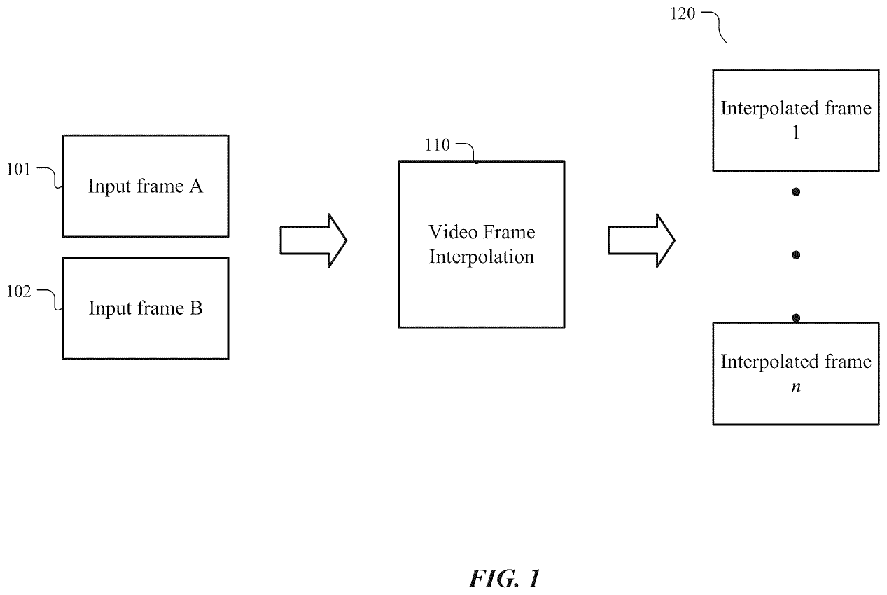

Video interpolation is a technique for increasing the number of frames in a video based on the video's original frames. For example, an original input video with 30 fps may have 60 fps after video interpolation. This is achieved by generating and inserting interpolated frames between adjacent frames in the original video. FIG. 1 provides a visualization of the video interpolation problem. A video may have any number of sequential frames. Input frame A 101 and input frame B 102 represent two adjacent frames in the input video. The two frames 101, 102 provide the necessary content information for a video frame interpolation process 110 to generate one or more interpolated frames 120, which will be inserted between the original two frames 101, 102 to generate a new video with a higher number of frames. Let's assume frame A 101 is associated with time t and frame B 102 is associated with time t+1. If three interpolated frames are to be inserted between those two original frames 101, 102, the three interpolated frames may be associated with times t+0.25, t+0.50, and t+0.75, respectively. The same number of interpolated frames may be inserted between each pair of adjacent frames in the original video to create a new up-sampled video. While the example in FIG. 1 shows a video interpolation process that uses a pair of adjacent frames to synthesize interpolated frames, one of ordinary skill in the art would recognize that other video interpolation processes may use additional input frames (e.g., 3, 4, or 5 adjacent frames) to generate interpolated frames. Using more frames in some cases may improve an interpolation module's ability to handle non-linear motion in the video.

Video interpolation faces the challenge of being potentially asked to handle any input video. For example, a social media platform might support an option to increase the framerate of videos that users upload. The scenes captured by users could be anything—one video could capture a basketball game, and another video could be a slow panning of a landscape. Between these two videos, interpolating the video of the basketball game would likely be more challenging since it contains a significant amount of rapid, non-linear motion. As another example, a video might include sudden changes in scenes (e.g., a video clip captured by a user walking in a building suddenly transitions into an outdoor scene). When scenes transition suddenly, blindly generating an interpolated frame between transition frames could result in severely distorted and unpredictable frames. Inserting such frames into the original video could be worse than not interpolating the video.

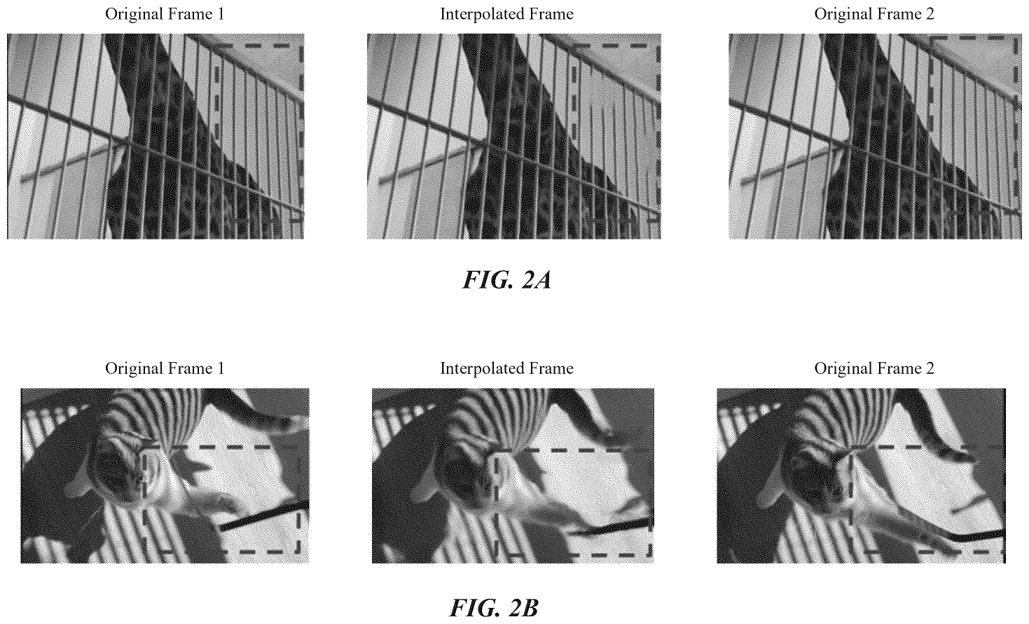

FIG. 2A and FIG. 2B illustrate examples of interpolated frames with noticeable errors. FIG. 2A shows two original frames 1 and 2 that are used to generate an interpolated frame. The original frames capture a giraffe behind a cage. The interpolated frame also shows a giraffe behind a cage, but the region surrounded by the dotted bounding box is inconsistent with the corresponding region in the two original frames. In the interpolated frame, the bars of the cage within the region in the bounding box are partially missing, which his incorrect. This type of artifact is often observed where there are repeated patterns in the scene. Another common cause for incorrect frame interpolation is when the scene includes a moving deformable object. For example, FIG. 2B shows a series of original frames 1 and 2 capturing a cat swinging its paw. The center interpolated frame is generated from original frames 1 and 2. The cat's paw in the interpolated frame, highlighted by the dotted bounding box, is noticeably deformed and does not accurately reflect how a cat's paw should look. This deformation/hallucination is another type of interpolation artifact that should be avoided.

The performance of video interpolation could also be limited by system resources and/or use cases. For example, a video interpolation module may be designed to run on a mobile phone or virtual-reality or augmented-reality headset, where computational resources and battery power are limited. To stay within operational or performance targets, the video interpolation module cannot be overly large or complex. As another example, video interpolation may need to be performed very quickly to reduce output latency (e.g., a video for live streaming may need to be output quickly to the viewer, or the output of a graphics pipeline may need to be quickly displayed on a virtual-reality headset to minimize lag). If so, the video interpolation module cannot be overly large or complex, since it needs to generate outputs quickly. However, a smaller and faster module usually is not sufficiently robust to handle every type of video input well. If there are unlimited computational resources and no time limit, a video interpolation module could be made very large and sophisticated so that it could successfully handle most input videos. However, even so, there would always be edge cases that the module cannot properly handle. Thus, given the practical limitations of video interpolation and the vast problem space, a video interpolation module would likely, at times, be tasked with interpolating a video that it cannot handle (i.e., the generated interpolated frames would have significant artifacts, distortions, hallucinations, etc.).

Embodiments described herein enable a video interpolation pipeline to dynamically anticipate the likely quality of an interpolated frame and decide on the type of interpolation technique to use. For example, if the video interpolation pipeline determines that the scene's characteristics are not suitable for interpolation based on the default interpolation module, it may select an alternative fallback module to generate the interpolated frame. For instance, if the estimated error is high, the pipeline's decision logic could choose to not perform interpolation at all and simply duplicate the input frame and use it as the interpolated frame. On the other hand, if the estimated error is low, the pipeline may choose to use the default machine-learning based interpolation module to synthesize the interpolated frame. In particular embodiments, the video interpolation pipeline may have multiple machine-learning based interpolation modules to select from. For example, one module may be a large machine-learning model that is computationally-expensive to run but can handle difficult cases, and another module may be small model that is cheaper to run but can only handle simple cases. With these different types of modules at its disposal, the video interpolation pipeline could choose to use the larger model when the error estimate is relatively high, and use the smaller model when the error estimate is relatively low. In particular embodiments, the video interpolation pipeline may divide each video frame into multiple regions and select interpolation modules for each region individually. For example, the video interpolation pipeline may generate an error map that identifies spatial regions within a frame that are likely be problematic. Regions that are more challenging could be interpolated using a larger, more sophisticated interpolation module, and regions that are simpler could be interpolated using a smaller, lightweight interpolation module.

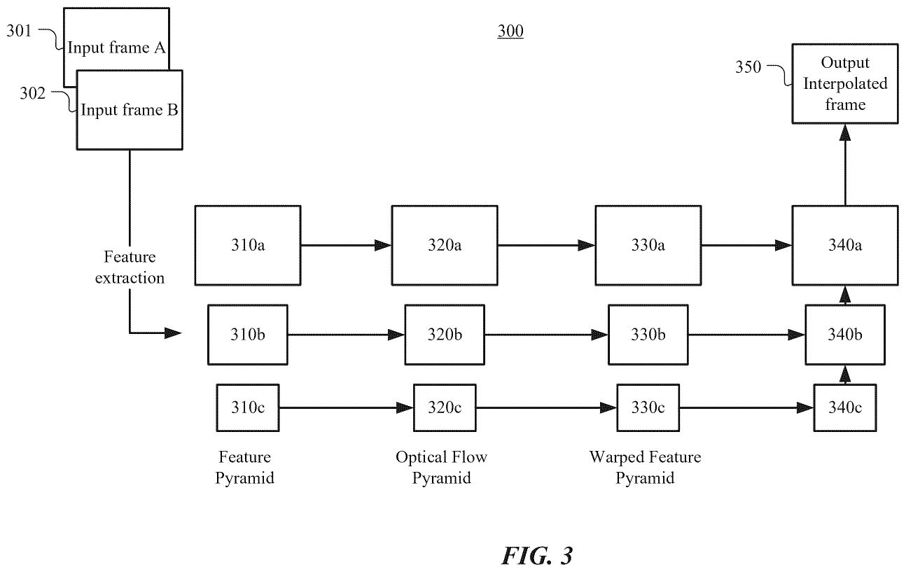

FIG. 3 illustrates a block diagram of a frame interpolation pipeline 300, according to particular embodiments. A given video may include one or more scenes. For example, a first scene may show a person driving, a second scene may show the person getting out of the car and walking, and a third scene may show the person in a restaurant. In particular embodiments, the video may be pre-processed to identify different scenes and separate them into clips, where each clip contains one scene. In particular embodiments, the video codec may contain information about distinct clips. In other embodiments, a machine-learning model or any other suitable technique to detect transitions between scenes and separate the scenes into clips.

In particular embodiments, each clip in the video containing a particular scene may be processed by the frame interpolation pipeline 300, which may run iteratively to generate interpolated frames for the clip. In particular embodiments, frame interpolation pipeline 300 may sequentially process a sliding window of adjacent frames in the original input video to generate interpolated frame(s). To illustrate, the input video may have a sequence of frames numbered from 1 to n. If the frame interpolation pipeline 300 is configured to generate interpolated frames from each pair of adjacent frames, then Frames 1 and 2 will be the first pair, Frames 2 and 3 will be the second pair, and so on, until the last pair, Frames n−1 and n, is processed. The interpolated frame(s) generated from Frames 1 and 2 will be inserted between Frames 1 and 2, the interpolated frame(s) generated from Frames 2 and 3 will be inserted between Frames 2 and 3, and so on. As previously mentioned, the number of frames in the sliding window could vary. For example, instead of using a pair of adjacent frames to perform interpolation, an alternative embodiment could use four adjacent frames. Using more frames would increase compute, but the additional frames could provide additional temporal information to assist with interpolation, which would be especially helpful for videos that include non-linear motion.

The example shown in FIG. 3 generates interpolated frame(s) 350 based on two input frames in a video (i.e., input frame A 301 and input frame B 302). In particular embodiments, the frame interpolation pipeline 300 uses machine learning to generate interpolated frames 350. The frame interpolation pipeline 300 may use one or more machine-learning models, which could be trained jointly or in an end-to-end manner. The input frames 301, 302 may first be processed by a first machine-learning model, which could be a convolutional neural network (CNN) or any other suitable machine-learning model. The first machine-learning model may extract features from input frame A 301 and generate a corresponding first feature map. Similarly, the first machine-learning model may extract features from input frame B 302 and generate a corresponding second feature map. In particular embodiments, the first machine-learning model may separately process the input frames 301, 302 to generate the two feature maps. In other embodiments, the input frames 301, 302 may be concatenated to form a six-channel tensor (the channels would correspond to the RGB channels of frame 301 and the RGB channels of frame 302), and the first machine-learning model may jointly process the six-channel tensor to generate the first and second feature maps. The first and second feature maps may have the same dimension and concatenate together in one tensor. FIG. 3 shows three pairs of first and second feature maps (i.e., 310a, 310b, and 310c).

In particular embodiments, it may be desirable to have the feature maps 310a be in different resolutions, which are represented in FIG. 3 as feature maps 310b and feature maps 310c. Together, the feature maps with different resolutions are referred to as a feature pyramid. The resolution of feature maps 310a is higher than both feature maps 310b and 310c, and the resolution of feature maps 310b is higher than feature maps 310c. In particular embodiments, the lower-resolution feature maps may be generated by down-sampling the higher-resolution feature maps (e.g., feature maps 310b and 310c may be generated by down-sampling feature maps 310a). Alternatively, the input frames 301, 302 may be down-sampled to reduce their resolutions, and the first machine-learning model could process them to generate the corresponding feature maps 310a-c. One benefit of having feature maps with different resolutions is that they allow the machine-learning model to reason at different levels of granularity/coarseness. Conceptually, processing the coarser levels of the feature maps (e.g., 310c) allows the machine-learning model to focus on the big picture, whereas processing the finer levels of the feature maps (e.g., 310a) allows the machine-learning model to focus on the details. While FIG. 3 illustrates three levels of granularity, this disclosure contemplates any other suitable levels, including one, two, four, five, six, etc.

In particular embodiments, a second machine-learning model (e.g., CNN layers or other suitable models) may be used to process each pair of feature maps (e.g., 310a, 310b, or 310c) to generate a corresponding pair of optical flow maps (e.g., 320a, 320b, or 320c), one forward and one backward. An optical flow map encodes the motion of corresponding features observed in two inputs, which could be input frames 301, 302 or their corresponding feature maps (e.g., 310a, 310b, or 310c). Like input frames 301, 302 (or their corresponding feature maps), an optical flow map may be implemented as a matrix or array of values (similar to a pixel array). Each pixel in the optical flow map stores a motion vector. The motion vector at a particular pixel location in the optical flow map may be associated with the same pixel location in a source input (e.g., input frame 301). The motion vector represents the motion trajectory of a feature at that particular pixel location in the source input (e.g., frame 301) and indicates where that feature is located in a destination input (e.g., frame 302). As an example, let's assume that a particular feature (e.g., the fingertip of a person) appears at pixel (x,y) in input frame 301, and the same corresponding feature is located at pixel (x′,y′) in input frame 302. A forward optical flow map would have a motion vector associated with pixel (x,y) that points to pixel (x′,y′). A backward optical flow map would have a motion vector associated with pixel (x′,y′) that points to pixel (x,y). However, the forward and backward optical flow maps, when generated with uncertainty, may not be perfectly aligned. For example, even if the forward optical flow map indicates that a pixel (x,y) appearing in frame 301 appears at pixel (x′,y′) in frame 302, the motion vector at pixel (x′,y′) in the backward optical flow map might not precisely point back to pixel (x,y) in frame 301. Instead, the motion vector at pixel (x′,y′) might point to pixel (x″, y″) in frame 301. Since pixel (x,y) is the expected location to which the motion vector at pixel (x′,y′) should point, the distance between pixel (x″,y″) and pixel (x,y) in frame 301 could represent an error or uncertainty with the motion at pixel (x,y).

The motion vectors in an optical flow map may be linearly scaled. For example, if input frame 301 is associated with time t and input frame 302 is associated with time t+1, scaling the forward optical flow map by 0.25 and using it to warp input frame 301 would result in an estimate of what the scene would look like at time t+0.25. Similarly, scaling the backward optical flow map by 0.75 and using it to warp input frame 302 would result in another estimate of what the scene would look like at time t+0.25. The same principal applies to optical flow maps 320a-c being used to warp feature maps 310a-c.

The second machine-learning model may process the high-resolution feature maps 310a to generate optical flow maps 320a, process the medium-resolution feature maps 310b to generate optical flow maps 310b, and so on. The resolution of the optical flow maps may be the same as that of its corresponding feature maps (e.g., the resolution of optical flow maps 320a is the same as feature maps 310a). Together, the optical flow maps 320a-c with different resolutions are referred to as an optical flow pyramid. The optical flow maps in each level of the pyramid (e.g., 320a, 320b, or 320c) include a forward optical flow map and a backward optical flow map. Assuming that input frame 301 precedes input frame 302, the forward optical flow map encodes motion from input frame 301 to input frame 302. The backward optical flow map encodes motion from input frame 302 back to input frame 301.

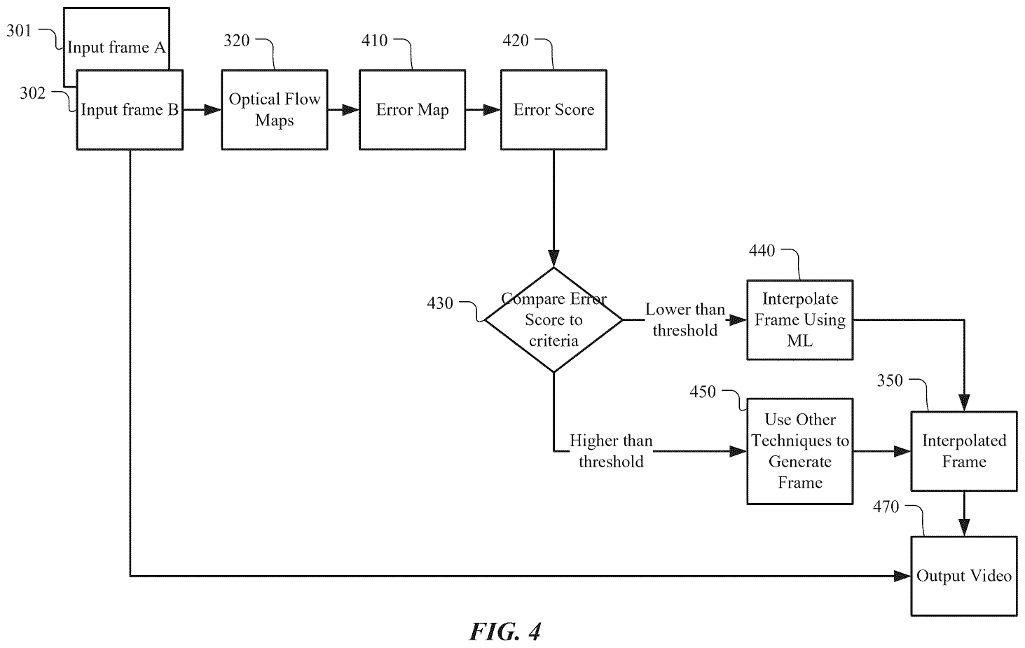

As will be described in further detail below with reference to FIG. 4, after the optical flow maps are generated, particular embodiments may use them to predict whether the optical flow maps 320a-c may be used to generate an error map, according to particular embodiments. Briefly, the error map identifies and quantifies motion uncertainty. The error map serves as a proxy for previewing the likelihood of the interpolated frame 350 having artifacts, distortions, or other inaccuracies. As such, the error map may be used by the pipeline 300 to determine which type of interpolation modules to use to generate the interpolated frame 350. For example, if there is no error, the pipeline 300 may determine that there is no motion, in which case the pipeline 300 would select an interpolation module that duplicates the input frame 301 to generate the interpolated frame 350. On the other extreme, if the error is too large, then the pipeline 300 may consider the frames to be from different scenes or the scene is too difficult to interpolate. As such, the pipeline 300 may not perform interpolation or select a module that simply duplicates the input frame 301 to generate the interpolated frame 350. If the error is within a safe range in which machine-learning-based interpolation would likely produce satisfactory results, the pipeline 300 may select such an interpolation module that uses machine-learning to generate the interpolated frame 350. In particular embodiments, the safe range may be subdivided into a higher range and a lower range. If the error map's error level is within the lower safe range, then the pipeline 300 may use a “standard” machine-learning-based module to generate the interpolated frame 350, such as the one shown in FIG. 3. If the error is in the higher error range (but still within the safe range), the pipeline 300 may select a larger, more powerful machine-learning module to generate the interpolated frame 350. In particular embodiments, the larger machine learning module may be similar to the “standard” module in terms of architecture and training methodology, but the larger module may have more CNN layers, more pyramid levels (e.g., instead of 3 levels, as shown in FIG. 3, the larger module may have 5 levels), larger kernel size, and/or more channels.

Returning to FIG. 3, the pipeline 300 may use optical flow maps 320a-c to warp the input frames 301, 302 and/or their corresponding feature maps 310a-c to a desired moment(s) in time that corresponds to the desired output interpolated frame 350. As previously mentioned, the forward optical flow map may be configured to encode motion from time t to time t+1, and the backward optical flow map may be configured to encode so motion from time t+1 back to time t. For example, let's assume input frame 301 corresponds to time t and input frame 302 corresponds to time t+1. The desired interpolated frame 350 may correspond to a time between the input frames 301, 302, such as time t+0.3. The desired time (e.g., t+0.3) relative to a scale defined by end times t and t+1, may be used to proportionally scale the forward and backward optical flow maps so that the scaled optical flow maps, when used to warp the input frames or feature maps, would warp them to the desired moment in time (e.g., t+0.3). For example, if the desired time for the interpolated frame 350 is t+0.3, then the forward optical flow map would be scaled by 0.3 (i.e., 30% of the range from t and t+1). Similarly, the backward optical flow map would be scaled by 0.7 (i.e., 70% of the range from t+1 to t). In particular embodiments, the pipeline 300 may generate a warped feature pyramid 330a-c by warping the feature pyramid 310a-c using the optical flow pyramid 320a-c, respectively. For example, feature maps 310a includes a first feature map associated with input frame 301 and a second feature map associated with input frame 302. The first feature map 310a is warped using the scaled forward optical flow map 320a to generate a first warped feature map 330a. The second feature map 310a is warped using the scaled backward optical flow map 320a to generate a second warped feature map 330a. In a similar manner, feature maps 310b are respectively warped using the scaled forward and backward optical flow maps 320b to generate a set of warped feature maps 330b. Lastly, feature maps 310c are respectively warped using the scaled forward and backward optical flow maps 320c to generate a set of warped feature maps 320c. The warped feature maps 330a-c represent how the feature maps 310a would look like at the desired time (e.g., t+0.3).

In particular embodiments, each of the warped feature maps 330a-c may optionally be concatenated with warped input frames in the RGB space. The warped input frames provide the subsequent machine-learning models additional information to infer the intermediate interpolated frames. Similar to the process of warping feature maps 310a-c, the optical flow maps 320a-c may be used to warp different resolutions of input frames 301, 302. For example, the aforementioned scaled forward and backward optical flow maps 320a may warp input frames 301 and 302, respectively, to generate warped input frames, which may then be concatenated with warped feature maps 330a. Similarly, the scaled forward and backward optical flow maps 320b may respectively warp lower-resolution versions of input frames 301 and 302 to generate another set of warped input frames, which are then concatenated with warped feature maps 330b. Likewise, the scaled forward and backward optical flow maps 320c may respectively warp an even lower-resolution versions of input frames 301 and 302 to generate another set of warped input frames, which are then concatenated with warped feature maps 330c.

The next stage in the pipeline 300 fuses the warped feature maps 330a-c, along with warped input frames optionally concatenated thereto, to generate the desired interpolated frame 350. In particular embodiments, the fusion process may be performed in a sequential fashion, from coarse to fine. For example, starting with the coarsest level in the warped feature pyramid, a third machine-learning model may process the warped feature maps 330c, along with warped input frames optionally concatenated thereto, to generate an output feature map 340c. The warped input frames provide the third machine-learning model with additional information to generate the desired interpolated frame 350. Thus, particular embodiments of the third machine-learning model may be configured to take as further input RGB data warped from input frames 301, 302, which represent the scene at the desired time (e.g., time t+0.3). The third machine-learning model may jointly process the warped feature maps 330c and warped input images to generate the output feature maps 340c.

The output feature map at a lower, coarser level may then be fused with the warped feature maps at a higher level. For example, output feature maps 340c may be up-sampled and concatenated with the warped feature maps 330b to generate a tensor. Again, the tensor may also include RGB information from the input frames (e.g., input frames 301 and 302 may be down-sampled and warped using the corresponding optical flow maps). The third machine-learning model may process the tensor to generate output feature maps 340b. The process then repeats: output feature maps 340b may be up-sampled and concatenated with warped feature maps 330a and/or the warped input frames 301, 302 to generate a final tensor. The final tensor may then be processed by a fourth machine-learning model (e.g., a few convolutional layers) that is configured to output an interpolated frame 350 (the output frame may have 3 channels corresponding to RGB). The interpolated frame 350 may then be inserted between the input frames 301, 302 to generate a final interpolated video. The pipeline 300 process may then repeat to generate the next interpolated frame for the next pair of input frames.

In particular embodiments, the aforementioned machine-learning models (e.g. first, second, third, and fourth machine-learning models) may be jointly trained in an end-to-end fashion. Each training data may include input frames (e.g., a pair of adjacent frames in a video) and a ground truth target frame representing the desired interpolation result. The machine-learning models may be trained iteratively. For example, in one training iteration, the aforementioned pipeline 300 may take a pair of input frames and generate an interpolated frame 350. The training algorithm may compare the interpolated frame 350 with the ground truth frame and compute one or more loss metrics (e.g., pixel-by-pixel differences between the interpolated frame 350 and the ground truth target). The loss metrics may then be back-propagated so that weights of the machine-learning models may be updated. Training may repeat in this fashion until a terminating condition is satisfied (e.g., a certain number of training iterations have been completed, or the loss metric stabilizes to be within a target threshold).

As previously discussed, particular embodiments of the pipeline 300 may include a checkpoint after optical flow maps are available to estimate whether the interpolated frame that is to be generated would likely have significant artifacts. Conceptually, optical flow maps generated from input frames that have predictable or obvious feature correspondences should, in theory, have high fidelity. Conversely, optical flow maps generated from input frames that are less predictable or lack clear correspondences should, in theory, have low fidelity. Thus, the fidelity of the optical flow maps could be used to detect difficult or challenging cases. By detecting such cases early before the interpolated frame 350 is generated, the pipeline 300 has an opportunity to use alternative methods to generate the interpolated frame 350.

FIG. 4 illustrates a flow diagram representing a technique for predicting the quality of interpolated frames before they are generated and using the predictions to make interpolation decisions in real-time. The process shown in FIG. 4 may be used during each iteration of frame interpolation. For example, in one iteration, the input frames 301 and 302 may be accessed from memory. The techniques described above with reference to FIG. 3 may be used to process the input frames 301, 302 and generate corresponding optical flow maps 320 (both forward and backward). The backward and forward optical flow maps 320 might not be perfect, as the changes between certain scenes may be inherently difficult to represent using optical flow (e.g., sudden scene changes, non-linear motion, etc.). As a result, the forward and backward optical flow maps 320 may have inconsistencies. To illustrate, when the forward and backward optical flow maps are consistent, one would expect that forward and backward warped pixel would be at the same starting location. Let's assume that a pixel (x,y) in a forward optical flow map has a corresponding motion vector that points to (x′,y′) in a destination frame. The pixel location (x′,y′) in a backward optical flow map has a corresponding motion vector that points to (x″,y″) in the source frame. When the motion vector at (x,y) in the forward optical flow map and the motion vector at (x′y′) in the backward optical flow map are consistent, the location (x″,y″) would be the same as (x,y). However, when there are inconsistencies between the motion vectors, (x″,y″) would be different from the original location (x,y). The magnitude of the distance between the starting location (x,y) and the forward- and backward-warped location (x″,y″) could, in some embodiments, be used to represent a level of error or uncertainty at the corresponding pixel location (x,y). A smaller distance represents higher certainty, and a larger distance represents lower certainty.

In particular embodiments, an error value corresponding to the distance between each pixel's location and its forward-and-backward warping location may be stored in an error map 410. For example, the error value stored at pixel (x,y) in the error map 410 may correspond to the distance between (x,y) and its forward-and-backward warped location (x″,y″), generated using the forward and backward optical flow maps. The error map 410 captures the uncertainty in the forward and backward optical flow maps at the pixel level. Areas with less certainty signal a lower likelihood of corresponding areas in the interpolated frame 350 being correct. In other words, the error map 410 serves as an early preview of areas in the interpolated frame 350 that would likely be generated incorrectly. Since the error map 410 may be cheaply computed using only the optical flow maps 320, it provides the pipeline 300 with an efficient means to predict areas in the interpolated frame 350 that would likely be incorrectly generated. An error map 410 may be generated for any level in the optical flow pyramid. For example, an error map may be generated for the high-level optical flow maps 320a, another error map may be generated for the mid-level optical flow maps 320b, and yet another error map may be generated for the low-level optical flow maps 320c.

The error map 410 may be analyzed in a variety of ways. In particular embodiments, the errors stored in the error map 410 may be aggregated to generate a representative error score 420 for the error map 410. For example, the error score 420 may be the sum, average, median, maximum, minimum, etc., of the error values in the error map 410. In particular embodiments, a filter may be applied to isolate errors in the error map 410 that are above or below a certain threshold. For example, a high-pass filter may isolate the errors that are above a certain threshold. Those errors may in turn be used to compute an error score 420. In further embodiments, the error map 410 may be divided into tiles or regions based on the errors they contain. For example, a region with a high concentration of errors may be segmented from regions with low error. Regions with different error concentrations may be processed using different interpolation techniques.

In particular embodiments, the error score 420 may be compared to one or more criteria 430 to determine which interpolation module to use. For example, an error score 420 that is extremely low (e.g., nearly no error) may be an indication that the frames 301, 302 are the same. In such cases, the selected interpolation module may simply duplicate one of the input frames 301, 302 to generate the interpolated frame 350. As another example, an error score 420 that is within a low predetermined range (e.g., low error, but non-negligible) may indicate that the input frames 301, 302 are different but have predictable motion. For such cases, a default machine-learning-based interpolation module 440 may be used (e.g., the third and fourth machine-learning models described with reference to FIG. 3). An error score that is in a relatively higher predetermined range may indicate that the input frames 301, 302 are likely challenging for the default machine-learning interpolation module 440 but are still sufficiently predictable for a larger, more sophisticated machine-learning interpolation module 450 to handle. In yet another example, if an error score 420 is higher than even the highest range associated with the large machine-learning interpolation module 450, then the input frames 301, 302 may be too challenging (e.g. rapid or large motion, etc.) or too different (e.g., during a scene transition, objects disappearing between frames, etc.) to interpolate. In such cases, rather than forcing an interpolation and using an interpolated frame 350 with significant distortions or errors, it may be preferable to select an interpolation module that simply duplicates one of the input frames 301, 302. Once the interpolated frame 350 is generated, it may be inserted between the input frames 301, 302 to generate an output video 470.

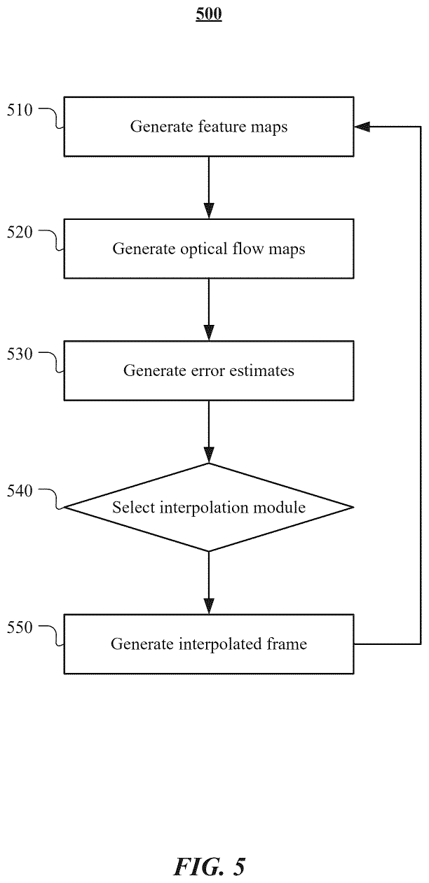

FIG. 5 illustrates an example method 500 for video interpolation. The method may begin at step 510, at which ha computing system may generate, based on a first input frame and a second input frame of an input video, a first feature map and a second feature map. At step 520, the system may generate a forward optical flow map and a backward optical flow map based on the first feature map and the second feature map. At step 530, the system may generate an error estimate using the forward optical flow map and backward optical flow map. At step 540, the system may select, based on a comparison of the error estimate and one or more criteria, an interpolation module from a plurality of interpolation modules. At step 550, the system may generate the interpolated frame using the selected interpolation module. The frame interpolation method 500 may then repeat at step 510 and generate additional interpolated frames for the next set of input frames. The generated interpolated frames may then be combined with the two input frames to generate at least a part of an output video. Particular embodiments may repeat one or more steps of the method of FIG. 5, where appropriate. Furthermore, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

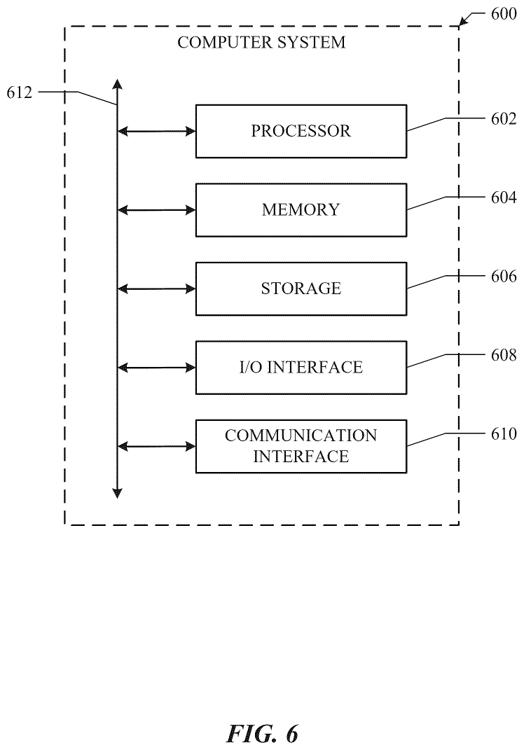

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method for generating an interpolated frame, comprising
generating, based on a first input frame and a second input frame of an input video, a first feature map and a second feature map;
generating a forward optical flow map and a backward optical flow map based on the first feature map and the second feature map;
generating an error estimate using the forward optical flow map and backward optical flow map;
selecting, based on a comparison of the error estimate and one or more criteria, an interpolation module from a plurality of interpolation modules;
generating the interpolated frame using the selected interpolation module; and
combining the interpolated frame with the two input frames to generate at least a part of an output video.

2. The method of claim 1, further comprising:
generating a first warped feature map using the forward optical flow map and the first feature map associated with the first input frame, the first warped feature map being associated with a desired time for which the interpolated frame is to be generated; and
generating a second warped feature map using the backward optical flow map and the second feature map associated with the second input frame, the second warped feature map being associated with the desired time;
wherein the first warped feature map and the second warped feature map are processed by the selected interpolation module to generate the interpolated frame.

3. The method of claim 2, further comprising:
generating a first warped input frame using the forward optical flow map and the first input frame, the first warped input frame being associated with the desired time for which the interpolated frame is to be generated; and
generating a second warped input frame using the backward optical flow map and the second input frame, the second warped input frame being associated with the desired time;
wherein the first warped input frame and the second warped input frame are additionally processed by the selected interpolation module to generate the interpolated frame.

4. The method of claim 1, wherein the comparison indicates that the error estimate is higher than a predetermined criterion, wherein the selected interpolation module generates the interpolated frame by duplicating either the first input frame or the second input frame.

5. The method of claim 1, wherein the comparison indicates that the error estimate is lower than a predetermined criterion, wherein the selected interpolation module is a machine-learning model.

6. The method of claim 5, wherein the machine-learning model is trained to process at least the first warped feature map and the second warped feature map to generate the interpolated frame.

7. The method of claim 5, wherein the machine-learning model is jointly trained in an end-to-end manner with one or more additional machine-learning models used to generate (1) the first feature map and the second feature map and (2) the forward optical flow map and the backward optical flow map.

8. One or more computer-readable non-transitory storage media embodying software that is operable when executed to:
generate, based on a first input frame and a second input frame of an input video, a first feature map and a second feature map;
generate a forward optical flow map and a backward optical flow map based on the first feature map and the second feature map;
generate an error estimate using the forward optical flow map and backward optical flow map;
select, based on a comparison of the error estimate and one or more criteria, an interpolation module from a plurality of interpolation modules;
generate the interpolated frame using the selected interpolation module; and
combine the interpolated frame with the two input frames to generate at least a part of an output video.

9. The one or more computer-readable non-transitory storage media of claim 8, wherein the software is operable when executed to:
generate a first warped feature map using the forward optical flow map and the first feature map associated with the first input frame, the first warped feature map being associated with a desired time for which the interpolated frame is to be generated; and
generate a second warped feature map using the backward optical flow map and the second feature map associated with the second input frame, the second warped feature map being associated with the desired time;
wherein the first warped feature map and the second warped feature map are processed by the selected interpolation module to generate the interpolated frame.

10. The one or more computer-readable non-transitory storage media of claim 9, wherein the software is operable when executed to:
generate a first warped input frame using the forward optical flow map and the first input frame, the first warped input frame being associated with the desired time for which the interpolated frame is to be generated; and
generate a second warped input frame using the backward optical flow map and the second input frame, the second warped input frame being associated with the desired time;
wherein the first warped input frame and the second warped input frame are additionally processed by the selected interpolation module to generate the interpolated frame.

11. The one or more computer-readable non-transitory storage media of claim 8, wherein the comparison indicates that the error estimate is higher than a predetermined criterion, wherein the selected interpolation module generates the interpolated frame by duplicating either the first input frame or the second input frame.

12. The one or more computer-readable non-transitory storage media of claim 8, wherein the comparison indicates that the error estimate is lower than a predetermined criterion, wherein the selected interpolation module is a machine-learning model.

13. The one or more computer-readable non-transitory storage media of claim 12, wherein the machine-learning model is trained to process at least the first warped feature map and the second warped feature map to generate the interpolated frame.

14. The one or more computer-readable non-transitory storage media of claim 12, wherein the machine-learning model is jointly trained in an end-to-end manner with one or more additional machine-learning models used to generate (1) the first feature map and the second feature map and (2) the forward optical flow map and the backward optical flow map.

15. A system comprising:
one or more processors; and
one or more computer-readable non-transitory storage media coupled to one or more of the processors and comprising instructions operable when executed by one or more of the processors to cause the system to:
generate, based on a first input frame and a second input frame of an input video, a first feature map and a second feature map;
generate a forward optical flow map and a backward optical flow map based on the first feature map and the second feature map;
generate an error estimate using the forward optical flow map and backward optical flow map;
select, based on a comparison of the error estimate and one or more criteria, an interpolation module from a plurality of interpolation modules;
generate the interpolated frame using the selected interpolation module; and
combine the interpolated frame with the two input frames to generate at least a part of an output video.

16. The system of claim 15, wherein the instructions are operable when executed to cause the system to:
generate a first warped feature map using the forward optical flow map and the first feature map associated with the first input frame, the first warped feature map being associated with a desired time for which the interpolated frame is to be generated; and
generate a second warped feature map using the backward optical flow map and the second feature map associated with the second input frame, the second warped feature map being associated with the desired time;
wherein the first warped feature map and the second warped feature map are processed by the selected interpolation module to generate the interpolated frame.

17. The system of claim 16, wherein the instructions are operable when executed to cause the system to:
generate a first warped input frame using the forward optical flow map and the first input frame, the first warped input frame being associated with the desired time for which the interpolated frame is to be generated; and
generate a second warped input frame using the backward optical flow map and the second input frame, the second warped input frame being associated with the desired time;
wherein the first warped input frame and the second warped input frame are additionally processed by the selected interpolation module to generate the interpolated frame.

18. The system of claim 15, wherein the comparison indicates that the error estimate is higher than a predetermined criterion, wherein the selected interpolation module generates the interpolated frame by duplicating either the first input frame or the second input frame.

19. The system of claim 15, wherein the comparison indicates that the error estimate is lower than a predetermined criterion, wherein the selected interpolation module is a machine-learning model.

20. The system of claim 19, wherein the machine-learning model is trained to process at least the first warped feature map and the second warped feature map to generate the interpolated frame.
